(19) United States
(12) Patent Application Publication
(10) Pub. No.: US 2001/0037504 A1
(43) Pub. Date: Nov. 1, 2001

(54) TV and control method of the same

(75) Inventors: Jae Kyung Lee, Daeku (KR); Myoung Hwa Ko, Gumi (KR)

Correspondence Address: FLESHNER & KIM, LLP, P.O. Box 221200, Chantilly, VA, 20153-1200, US

(73) Assignee: LG ELECTRONICS INC.

(21) Appl. No.: 09/840,881

(22) Filed: Apr. 25, 2001

(30) Foreign Application Priority Data
Apr. 27, 2000 (KR) 22561/2000

(51) Int. Cl. G06F 3/00; H04N 5/445; G06F 13/00

(52) U.S. Cl. 725/60

(57) ABSTRACT

The present invention relates to a TV and a control method of the same which is capable of displaying function information and feature information of a TV in accordance with a request of a user, in particular to a digital TV in accordance with the present invention comprises a product-related site server for providing product-related information, a storing unit for storing the proper information of a product and contact information of a certain site, and a controlling unit for controlling in order to display the product-related information on a screen by using the contact information and proper information, accordingly a user can receive product information easily and can understand easily functions of the product.

### BACKGROUND OF THE INVENTION

1. Field of the Invention

The present invention relates to a TV (television), in particular to a TV (Television) and a control method of the same which is capable of providing function information and feature information of the TV.

2. Description of the Prior Art

Recently, a method for transmitting a broadcast signal has been developed along with technology development about a TV, according to it interest about a digital TV adapting a digital transmission method is on the increase.

Generally, a digital broadcast means transmitting a transport stream, herein the transport stream is a digital signal as video, audio, data and broadcast information are temporal-multiplexed by packet units. More detailed description about the transport stream is mentioned in an international standard ‘ISO (International Standard Organization)/IEC (International Electro-technical Commission) 13818’.

Data such as interactive broadcast data, program downloading data, a software program etc. can be comprised in the transport stream.

In the meantime, the broadcast signal comprises a tuning frequency required for a broadcast reception, a packet identifier for identifying a packet of a video/audio/data signal, and broadcast scheduling information. Herein, the broadcast information adapts a different standard according to each broadcast method.

Recently, technology development about the digital TV is proceeding actively, performing a test broadcast or a regular broadcast about the digital TV is possible in the present phase.

Hereinafter, a construction of a general digital TV according to the prior art will be described with reference to accompanying FIG. 1.

FIG. 1 is a block diagram illustrating a construction of a general digital TV in accordance with the prior art.

As depicted in FIG. 1, the general digital TV comprises a tuner 101 for tuning in to a broadcast signal of a user selection channel among broadcast signals of each channel received through an antenna, an analog/digital converter 104 for converting the user selection broadcast signal into a digital signal, a link 105 for correcting an error by demodulating the digital signal, converting it into a transport stream format and outputting it, a remote controller interface 102 for inputting a user request signal, a controlling unit 106 for demultiplexing the transport stream in accordance with the user request signal or outputting a control signal for controlling the tuner 101, a MPEG (Moving Picture Expert Group) A/V (Audio/Video) decoder 107 for being inputted the demultiplexed signal from the controlling unit 106, converting it into decoded audio and video signals and outputting them, a NTSC (National Television System Committee) encoder 108 for outputting a luminance signal and a color signal by encoding the decoded video signal in order to display it on a screen, a digital/analog converter 112 for converting a digital audio signal into an analog audio signal and outputting it in order to output the decoded audio signal through a speaker, a SDRAM (Synchronous Dynamic Random Access Memory) 103 for storing data required in the decoding process, a DRAM (Dynamic Random Access Memory) 111 for storing temporary data in accordance with a control operation of the controlling unit 106, and a flash memory 109 for storing a program for a control operation of the controlling unit 106. The operation of the general digital TV will now be described as below.

First, the tuner 101 tunes in to a broadcast signal of a user selection channel among broadcast signals of each channel received through the antenna. Herein, the controlling unit 106 makes a transmitter corresponding to a broadcast signal of the user selection signal convert into an intermediate frequency (497.5 MHz) by transmitting a frequency value of a certain transmitter among transmitters having a different frequency value at every transmitter (not shown) to a PLL (Phase Locked Loop) (not shown) inside the tuner 101.

After that, the tuner 111 outputs the broadcast signal of the user selection channel into the A/D converter 104.

The A/D converter 104 is inputted the broadcast signal of the user selection channel, converts in into a digital signal, and outputs it to the link 105.

The link 105 is inputted the digital signal, demultiplexes it, corrects an error, converts it into a transport stream format, and outputs it to the controlling unit 106 through a bus line. Herein, the controlling unit 122 includes a CPU, a demultiplexer, and a communication port etc. The transport stream means a digital signal as a video signal, an audio signal, data and broadcast information are temporal-multiplexed by packet units.

After that, the demultiplexer of the controlling unit 106 is inputted the transport stream, and outputs it as the demultiplexed video signal, audio signal, and additional information to the MPEG AN decoder 107. Herein, the demultiplexing means detecting a packet identifier included in the broadcast signal and discriminating it into a video signal sequence, an audio signal sequence, and an additional information sequence.

The MPEG A/N decoder 107 is inputted the demultiplexed video and audio signals, converts them into decoded video and audio signals by passing through the SDRAM 103, and outputs them. Herein, data base structuring of the additional information is performed in order to be displayed with a GUI (Graphic User Interface).

The NTSC encoder 108 outputs a luminance signal and a color signal by encoding the decoded video signal outputted from the MPEG AN decoder 107 into a NTSC signal in order to display it on a screen.

The D/A converter 112 converts the decoded audio signal outputted from the MPEG A/V decoder 107 into an analog audio signal, and outputs it to a speaker.

In the meantime, the network interface 110 is for performing a two-way communication such as an internet etc., control-related data is transmitted/received to the controlling unit 106 through the bus line, and video and audio related-data is outputted to the MPEG A/V decoder 107 though the bus line.

However, the digital TV in accordance with the prior art can not provide function description and feature information about the digital TV through the network interface, accordingly it is inconvenient for the user in usage of the TV.

### SUMMARY OF THE INVENTION

The object of the present invention is to provide a TV and a control method of the same which is capable of displaying function description and feature information etc. of a TV in accordance with a request of a user.

In order to achieve the objects of the present invention, in an apparatus for reproducing video and audio signals by receiving a broadcast signal, the TV in accordance with the present invention comprises a storing unit for storing the proper information of a product and contact information of a certain site, and a controlling unit for displaying function information and feature information of the product on a screen by using the contact information and proper information.

In order to achieve the objects of the present invention, the control method of the TV in accordance with the present invention comprises transmitting the proper information of a product to a certain site, receiving menu information corresponding to the product, receiving information selected by a user in the menu information, and displaying the selected information on a screen.

### BRIEF DESCRIPTION OF THE DRAWINGS

FIG. 1 is a block diagram illustrating a construction of a general digital TV in accordance with the prior art.

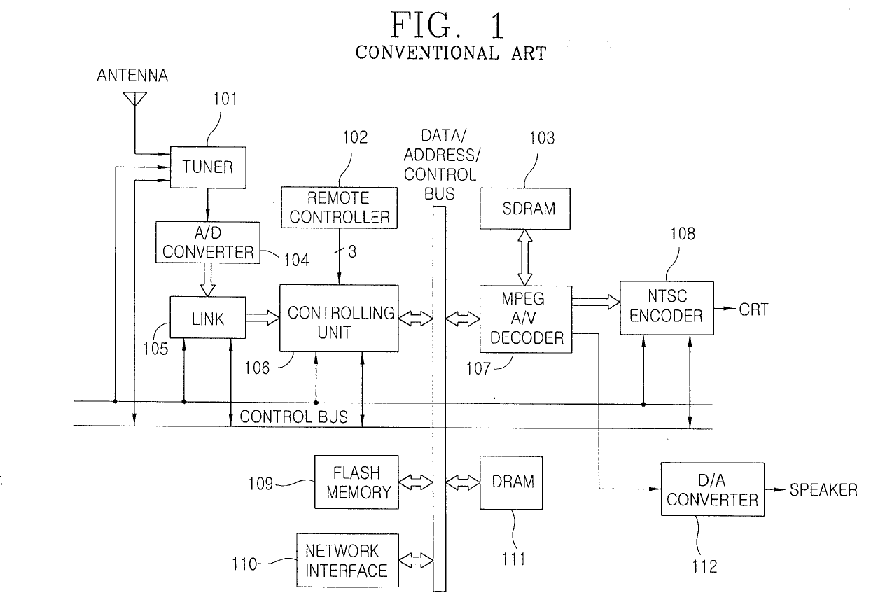

FIG. 2 is a block diagram illustrating a construction of a digital TV in accordance with the present invention.

FIG. 3 illustrates a storing unit of FIG. 2 in detail.

FIG. 4 is a flow chart illustrating a control method of a digital TV in accordance with the present invention.

FIG. 5 is a flow chart illustrating an operation of a product-related site server of a digital TV in accordance with the present invention.

FIG. 6 illustrates performing process of a simulator in accordance with the present invention.

### DETAILED DESCRIPTION OF THE PREFERRED EMBODIMENT

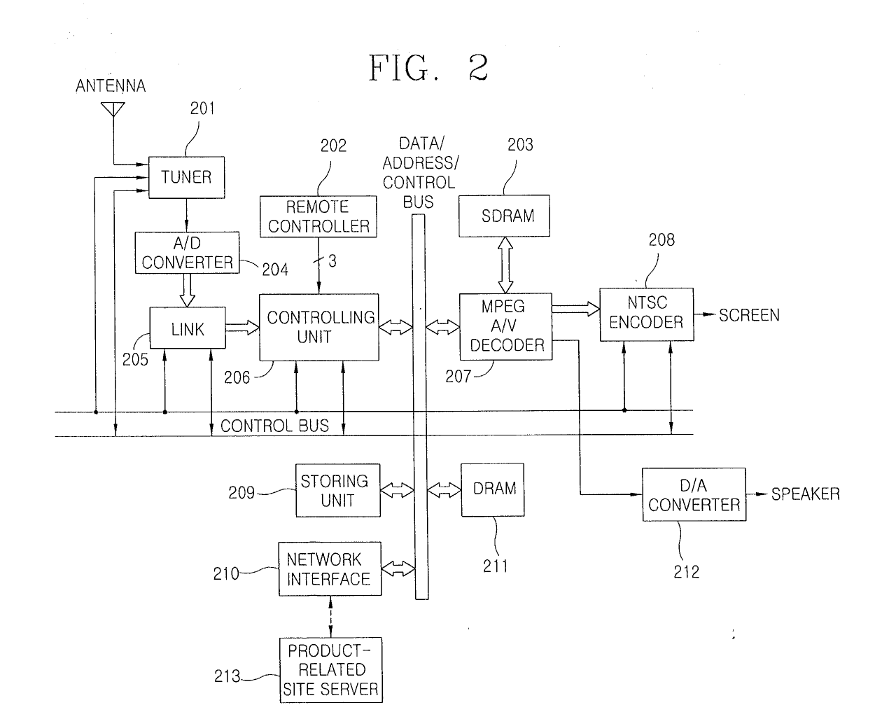

Hereinafter, a digital TV and a control method of the same in accordance with the present invention will now be described in detail with reference to accompanying FIGS. 2-6.

FIG. 2 is a block diagram illustrating a construction of a digital TV in accordance with the present invention.

As depicted in FIG. 2, the digital TV in accordance with the present invention comprises a tuner 201 for tuning in to a broadcast signal of a user selection channel among broadcast signals of each channel received through an antenna, an analog/digital converter 204 for converting the user selection broadcast signal into a digital signal, a link 205 for correcting an error by demodulating the digital signal, converting it into a transport stream format and outputting it, a remote controller interface 202 for inputting a user request signal, a controlling unit 206 for demultiplexing the transport stream in accordance with the user request signal or outputting a control signal for controlling the tuner 201, a MPEG (Moving Picture Expert Group) A/V decoder 207 for receiving the demultiplexed signal from the controlling unit 206, converting in into decoded audio and video signals and outputting them, a NTSC (National Television System Committee) encoder 208 for outputting a luminance signal and a color signal by encoding the decoded video signal in order to display it on a screen, a digital/analog converter 212 for converting the decoded audio signal into an analog audio signal and outputting it through a speaker, a network interface 210 for performing a two-way communication such as an internet etc., a product-related site server 213 for providing a product-related menu through the network interface 210, a SDRAM (Synchronous Dynamic Random Access Memory) 203 for storing data required in the decoding process, a DRAM (Dynamic Random Access Memory) 211 for storing temporary data in accordance with the control operation of the controlling unit 206, and a storing unit 209 for storing a program for the control operation of the controlling unit 206, the proper information of the pertinent product and contact information of the service-related site.

Herein, the controlling unit 206 contacts to the product-related site server 213 by using the contact information of the service-related site stored in the storing unit 209, transmits the proper information of a pertinent product (TV), is inputted an order code corresponding to the user selection menu from the product-related site server 213, and controls in order to display information corresponding to the order code on a screen.

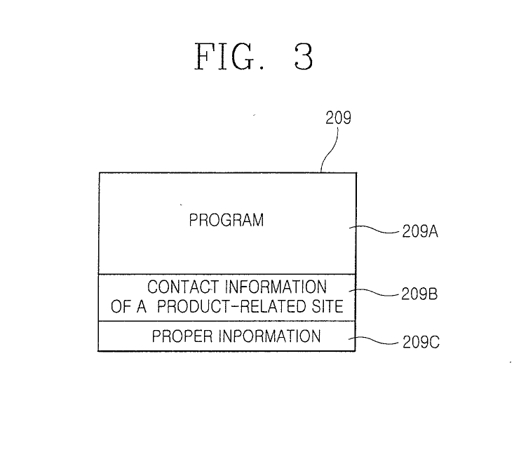

FIG. 3 illustrates the storing unit of FIG. 2 in detail.

As depicted in FIG. 3, the storing unit 209 comprises a region 209A for storing a program for a control operation of the controlling unit 206, a region 209B for storing the contact information of the service-related site, and a region 209C for storing the proper information of the pertinent product. Herein, the contact information can be a URL (uniform Resource Locator) etc.

Hereinafter, the operation of the digital TV in accordance with the present invention will now be described in detail.

First, when a user has a difficulty to understand a function of a product (TV) or judges an error occurrence of the product (TV), the user inputs (pushes) a function selection key (not shown) in order to get information about the product (TV), and the controlling unit 206 contacts to the product-related site server 213 through the network interface unit 210 by referencing the contact information of the service-related site stored in advance in the storing unit 209.

When the controlling unit 206 contacts to the product-related site server 213, the controlling unit 206 transmits the proper information of the pertinent product stored in advance in the storing unit 209 to the product-related site server 213. Herein, the proper information can be a model name or a model number of the TV.

The product-related site server 213 is inputted the proper information, and transmits the product-related menu information to the controlling unit 206.

The controlling unit 206 displays the product-related menu information on the screen of the TV. Herein, the user selects a user request menu by referencing the product-related menu information displayed on the screen. Herein, the product-related menu information describes video-related information, audio-related information, feature information of a TV, a special function of a TV etc.

After that, when the user selects the user request menu in the product-related menu information, the controlling unit 206 transmits selection information corresponding to the user request menu to the product-related site server 213 through the network interface 241.

The product-related site server 213 transmits the order code for transmitting information corresponding to the selection information by receiving the selection information to the controlling unit 206 through the network interface 210. Herein, the controlling unit 206 is inputted the order code, and controls to display information corresponding to the user selection menu among functions included in the product-related menu information on a screen.

Accordingly, function information and feature information related to the TV requested by the user can be provided by performing a two-way communication between the TV and product-related site server 213.

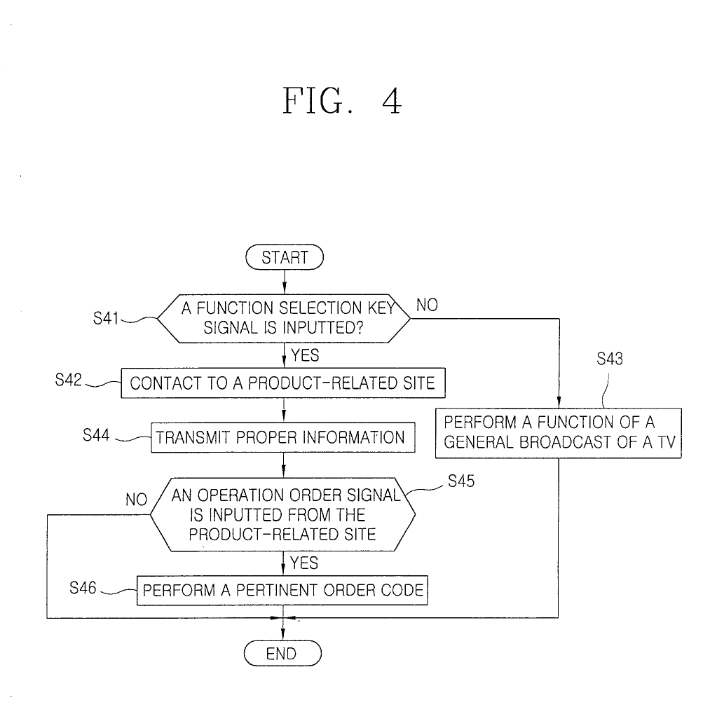

Hereinafter, the control method of the TV in FIGS. 2 and 3 in accordance with the present invention will now be described in detail with reference to accompanying FIG. 4.

FIG. 4 is a flow chart illustrating the control method of the digital TV in accordance with the present invention.

First, the controlling unit 206 judges whether a function selection key signal is inputted from a user S41.

When the function selection key signal is inputted, the controlling unit 206 contacts to the product-related site server 213 through the network interface 210 by referencing the contact information of the service-related site stored in advance in the storing unit 209 S42.

When the controlling unit 206 contacts to the product-related site server 213, the controlling unit 206 transmits the proper information of the pertinent product (TV) to the product-related site server 213 S44.

After that, the controlling unit 206 judges whether an operation order signal is inputted from the product-related site server 213 S45. In other words, the controlling unit 206 judges whether information corresponding to the selection information is inputted form the product-related site server 213.

When the operation order signal is inputted from the product-related site server 213, the controlling unit 206 performs an order code according to the operation order signal S46. In other words, the controlling unit 206 is inputted information corresponding to the user selection menu, and controls to display it on the screen of the TV.

In the meantime, when the function selection key signal is not inputted, the controlling unit 206 performs a function of the TV S43. Herein, the function of the TV means a function of a general TV which selects a broadcast signal of a user request channel and outputs video and audio signals corresponding to the selected broadcast signal.

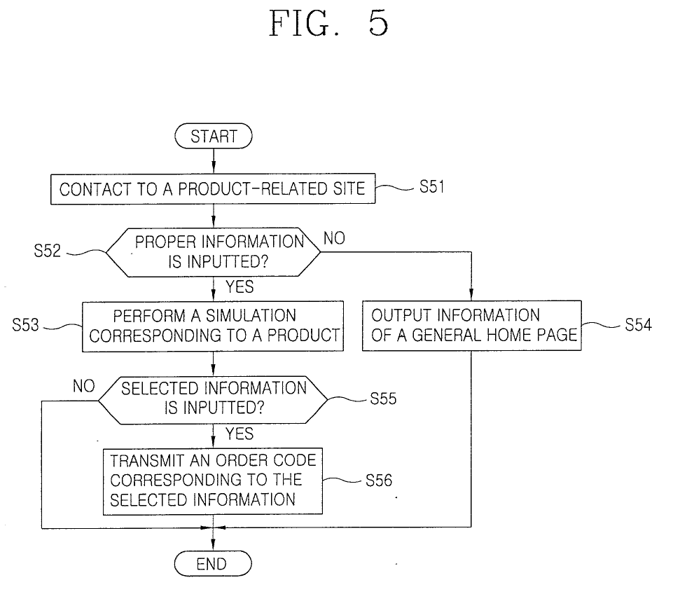

As descried above, the proper information of the product (TV) (the proper information of a pertinent product) is inputted from a manufacturer to the product-related site server 213, the product-related site server 213 outputs the product-related information corresponding to the product to the controlling unit 206 of the TV through the network interface 210. It will now be described in detail with reference to accompanying FIG. 5.

FIG. 5 is a flow chart illustrating an operation of a product-related site server of a digital TV in accordance with the present invention.

First, when the TV contacts to the product-related site server 213 S51, the product-related site server 213 judges whether the proper information of the pertinent product is inputted through the network interface 210 of the TV S52.

When the proper information of the pertinent product is inputted, the product-related site server 213 performs a simulation S53. At the same time, the product-related site server 213 outputs the product-related menu information to the controlling unit 206. Herein, the user can select request information in the product-related menu information displayed on the screen of the TV.

After that, the product-related site server 213 judges whether the selection information is inputted from the controlling unit 206 of the TV S55. In other words, it judges whether the selection information requesting request information in the product-related menu information displayed on the screen of the TV is inputted.

When the selection information is inputted, the product-related site server 213 transmits the order code corresponding to the selection information to the controlling unit 206 through the network interface 210 of the TV S56.

In the meantime, when the proper information or the pertinent product is not inputted to the product-related site server 213, the product-related site server 213 outputs the general home page information to the controlling unit 206 of the TV S54.

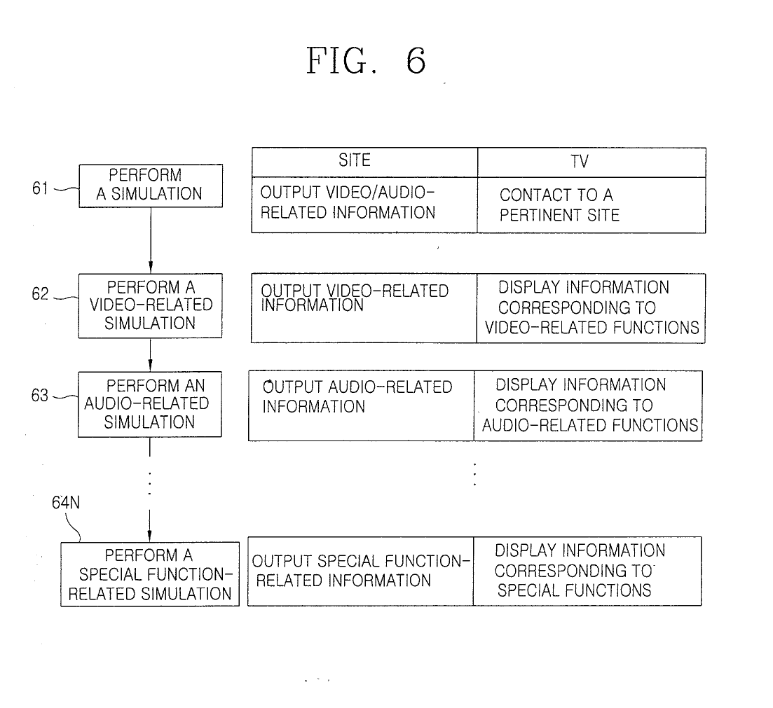

As described above, in the digital TV in accordance with the present invention, when the user wants to receive description about the function and feature of the TV and the proper information of the pertinent model is transmitted to the product-related site server 213 through the network interface 210, the product-related site server 213 performs the simulation operation about the pertinent model. The process for performing the simulation will now be described in detail with reference to accompanying FIG. 6.

FIG. 6 illustrates process for performing the simulation in accordance with the present invention.

First, when the simulation is performed in the product-related site server 213, the product-related site server 213 transmits information corresponding to the video-related functions of the TV, information corresponding to the audio-related functions, special function-related information to the controlling unit 206 through the network interface 210. Herein, the controlling unit 206 controls to display the information corresponding to the video-related functions of the TV, information corresponding to the audio-related functions, special function-related information etc. on the screen.

For example, when the video-related simulation of the TV is performed in the product-related site server 213 S62, the product-related site server 213 outputs the video-related information. Herein, the control unit 206 of the TV is inputted the video-related information of the TV, and controls to display the information corresponding to the video-related functions on the screen.

In addition, when the audio-related simulation of the TV is performed in the product-related site server 213 S63, the product-related site server 213 outputs the audio-related information. Herein, the controlling unit 206 of the TV is inputted the audio-related information of the TV, and controls to display the information corresponding to the audio-related functions of the TV on the screen.

In addition, when the special function-related simulation of the TV is performed in the product-related site server 213 S64N, the product-related site server 213 outputs the special function-related information. Herein, the controlling unit 206 of the TV is inputted the special function-related information of the TV, and controls to display the information corresponding to the special function-related functions of the TV on the screen.

As described above, the digital TV in accordance with the present invention is inputted the information corresponding to the video-related functions of the TV, information corresponding to the audio-related functions, special function-related information from the product-related site server 213, and displays function information corresponding to them, accordingly the user can understand the function of the product easily.

As described above, the digital TV and control method of the same in accordance with the present invention is capable of displaying functions and feature information (special function) of a product on the screen, accordingly the present invention can easily provide product information to the user, and improve sales promotion and understanding of the user (viewer).

What is claimed is:

1. In an apparatus reproducing video and audio signals by receiving a broadcast signal, a TV, comprising:
a storing unit for storing proper information of a product, and contact information of a certain site; and
a controlling unit for displaying function information and feature information of the product on a screen by using the contact information and proper information.

2. The TV according to claim 1, wherein the certain site is a product-related site.

3. The TV according to claim 1, wherein the function information and feature information of the product is provided from a product-related site server.

4. The TV according to claim 1, wherein the controlling unit transmits the proper information of the product to the product-related site server.

5. The TV according to claim 1, wherein the proper information of the product is contacted to the product-related site server through a network interface.

6. The TV according to claim 1, wherein the proper information is a model name or a model number of the product.

7. The TV according to claim 1, wherein the contact information is a URL (Uniform Resource Locator) of the certain site.

8. The TV according to claim 1, wherein the function information is information corresponding to video or audio-related functions.

9. The TV according to claim 1, wherein the feature information is information corresponding to a special function.

10. A control method of a TV, comprising:
transmitting proper information of a product to a certain site;
receiving menu information corresponding to the product;
receiving information selected by a user in the menu information; and
displaying the selected information on a screen.

11. The control method of the TV according to claim 10, wherein the proper information is a model name or a model number of the product.

12. The control method of the TV according to claim 10, wherein the proper information is transmitted by using contact information of the certain site.

13. The control method of the TV according to claim 12, wherein the contact information is a URL (Uniform Resource Locator).

14. The control method of the TV according to claim 10, wherein the certain site is a product-related site.

15. The control method of the TV according to claim 10, wherein the menu information is information corresponding to video or audio-related functions, and information corresponding to a special function.

16. The control method of the TV according to claim 10, wherein the transmitting process transmits the proper information to the certain site by using the contact information of the product-related site stored in advance when a function selection key signal is inputted by a user.

17. The control method of the TV according to claim 16, wherein the control method further comprises receiving and processing a broadcast signal when the function selection key signal is not inputted.

18. The control method of the TV according to claim 10, wherein the control method further comprises displaying general homepage information on a screen after receiving it when the proper information is not transmitted to the certain site.
